(19) United States
(12) Patent Application Publication
(10) Pub. No.: US 2012/0305596 A1
(43) Pub. Date: Dec. 6, 2012

(54) Liquid Crystal Dispensing Device with Temperature Control

(75) Inventor: Chien-Pang Lee, Shenzhen City (CN)

(73) Assignee: Shenzhen China Star Optoelectronics Technology Co. Ltd., Shenzhen City, Guangdong (CN)

(21) Appl. No.: 13/260,332

(22) PCT Filed: Jun. 20, 2011
(86) PCT No.: PCT/CN2011/075910

§ 371 Date: Sep. 25, 2011

(30) Foreign Application Priority Data
Jun. 2, 2011 (CN) 201110148941.6

(51) Int. Cl. B67D 7/80

(52) U.S. Cl. 222/146.1

(57) ABSTRACT

The present invention provides a liquid crystal dispensing device having temperature control. The liquid crystal dispensing device is to mount at least one temperature controller on a liquid crystal tank, a delivery pipe or a liquid crystal dropping nozzle to reduce viscosity of liquid crystal before dropping the liquid crystal on a substrate, so as to reduce the impact made on the alignment film of the substrate when dropping the liquid crystal and thereby reduce occurrence of drop-mura defect after dropping liquid crystal.

### FIELD OF THE INVENTION

The present invention relates to a liquid crystal dispensing device, and more particularly to a liquid crystal dispensing device having temperature control.

### BACKGROUND OF THE INVENTION

A conventional liquid crystal dispensing technique of liquid crystal panel manufacturing process is to slowly fill a gap between two assembled glass substrates with liquid crystal by capillarity. Such technique is time-consuming and may waste liquid crystal materials.

The aforementioned liquid crystal dispensing technique is gradually replaced by an ODF (One Drop Filling) technique. The ODF technique is to first directly drop liquid crystal onto one glass substrate by a liquid crystal dispensing device, and the glass substrate is then assembled with another glass substrate. This new technique can greatly save the time on fill-in liquid crystal and the material cost.

However, as for producing certain liquid crystal panel that is to improve its view angle with liquid crystal alignment, when dropping the liquid crystal on an alignment film on the substrate by the ODF technique, a drop-mura defect may occur due to the impact that liquid crystal drops made on the alignment film. The current improvement method, as shown in FIG. 1, is to increase the amount of liquid crystal drops 900 and meanwhile decrease the volume of each drop of liquid crystal, so as to overcome the drop-mura defect. However, such method has only a limited effect, and increasing the number of liquid crystal drops and decreasing the volume of each drop of liquid crystal may influence the operation accuracy of the liquid crystal dispensing device and increase manufacturing time of filling liquid crystal.

Hence, it is necessary to provide a liquid crystal dispensing device having temperature control to overcome the problems existing in the conventional technology.

### SUMMARY OF THE INVENTION

In view of the shortcomings of the conventional technique, a primary object of the invention is to provide a liquid crystal dispensing device having temperature control that reduce occurrence of drop-mura defect when dropping liquid crystal.

To achieve the above object, the present invention provides a liquid crystal dispensing device having temperature control comprising:

a liquid crystal tank storing liquid crystal;

a delivery pipe connected to the liquid crystal tank;

a liquid crystal dropping nozzle connected to the delivery pipe; and

at least one temperature controller mounted on a delivery path constructed by the liquid crystal tank, the delivery pipe and the liquid crystal dropping nozzle and controlling temperature of the liquid crystal to maintain viscosity of the liquid crystal in a range of 7 mPa·s to 15 mPa·s before dropping the liquid crystal.

In one embodiment of the present invention, the liquid crystal dispensing device has a temperature controller that is selectively attached to a side of the liquid crystal tank, the delivery pipe or the liquid crystal dropping nozzle.

In one embodiment of the present invention, the liquid crystal dispensing device has a first, a second and a third temperature controllers attached to a side of the liquid crystal tank, the delivery pipe and the liquid crystal dropping nozzle, respectively.

In one embodiment of the present invention, the temperature controller has a heating component used to heat the liquid crystal in the liquid crystal tank, the delivery pipe or the liquid crystal dropping nozzle.

In one embodiment of the present invention, the temperature controller further has a sensing unit and a control unit, wherein the sensing unit is used to sense the temperature of the liquid crystal in the liquid crystal tank, the delivery pipe or the liquid crystal dropping nozzle and send corresponding temperature information to the control unit; the control unit is used to adjust the heating temperature of the heating component according to the temperature information.

In one embodiment of the present invention, the first, the second and the third temperature controllers respectively have a heating component used to heat the liquid crystal in the liquid crystal tank, the delivery pipe or the liquid crystal dropping nozzle.

In one embodiment of the present invention, each of the first, the second and the third temperature controllers further has a sensing unit and a control unit, wherein the sensing unit is used to sense the temperature of the liquid crystal in the liquid crystal tank, the delivery pipe or the liquid crystal dropping nozzle and send corresponding temperature information to the control unit; the control unit is used to adjust the heating temperature of the heating component according to the temperature information.

The present invention is to mount at least one temperature controller on a path of delivering liquid crystal to reduce viscosity of the liquid crystal and reduce the impact made on an alignment film when dropping the liquid crystal and thereby reduce occurrence of drop-mura defect.

### DESCRIPTION OF THE DRAWINGS

FIG. 1 is a schematic view showing increasing an amount of liquid crystal drops 900 and decreasing a volume of each drop of liquid crystal according to the prior art;

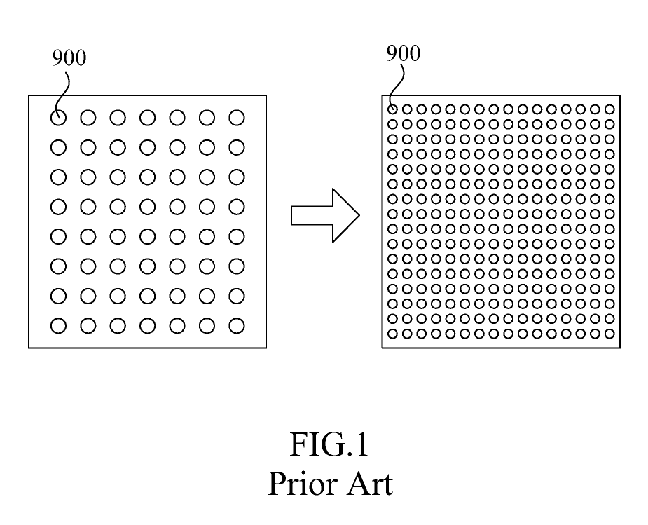

FIG. 2 is a block diagram of a first embodiment of a liquid crystal dispensing device having temperature control in accordance with the present invention;

FIG. 3 is a block diagram of a second embodiment of the liquid crystal dispensing device having temperature control in accordance with the present invention; and

FIG. 4 is a characteristic curve chart of viscosity to temperature of liquid crystal.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

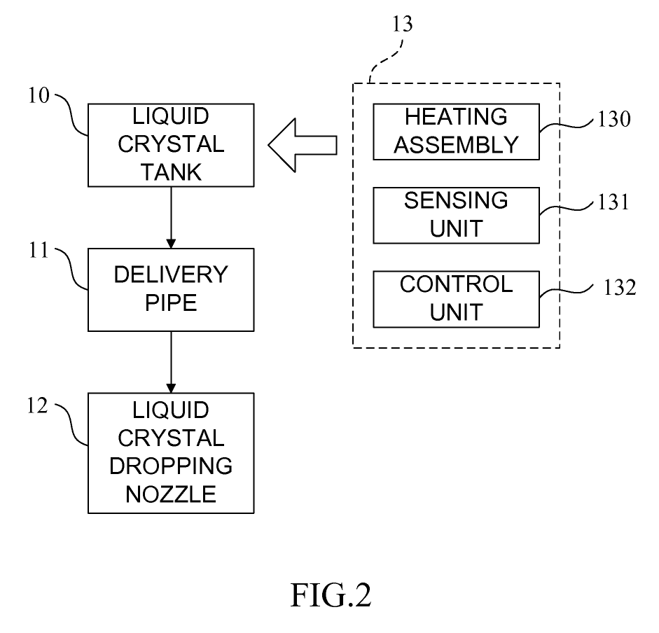

With reference to FIG. 2, FIG. 2 is a block diagram of a first embodiment of a liquid crystal dispensing device having temperature control in accordance with the present invention. The liquid crystal dispensing device has a liquid crystal tank 10, a delivery pipe 11, a liquid crystal dropping nozzle 12 and a temperature controller 13.

The liquid crystal tank 10 is used to store liquid crystal. The liquid crystal tank 10 may be fixed on a base.

The delivery pipe 11 is connected to the liquid crystal tank 10 and is used to deliver the liquid crystal stored in the liquid crystal tank 10.

The liquid crystal dropping nozzle 12 is connected to the delivery pipe 11 and is used to derive the liquid crystal from the delivery pipe 11 and dispense the liquid crystal like water drops on an alignment film of a glass substrate. The liquid crystal dropping nozzle 12, the delivery pipe 11 and the liquid crystal tank 10 then construct a delivery path for liquid crystal.

The temperature controller 13 is mounted on the delivery path constructed by the liquid crystal tank 10, the delivery pipe 11 and the liquid crystal dropping nozzle 12 and may be selectively attached to a side of the liquid crystal tank 10, the delivery pipe 11 or the liquid crystal dropping nozzle 12. In this embodiment, the temperature controller 13 is attached to a side of the liquid crystal tank 10 and has a heating component 130, so as to control temperature of the liquid crystal in the liquid crystal tank 10 by heating. Furthermore, the temperature controller 13 further has a sensing unit 131 and a control unit 132. The sensing unit 131 is used to sense the temperature of the liquid crystal in the liquid crystal tank 10 and send corresponding temperature information to the control unit 132. The control unit 132 is used to adjust the heating temperature of the heating component 130 according to the received temperature information, so as to stably control the temperature of the liquid crystal.

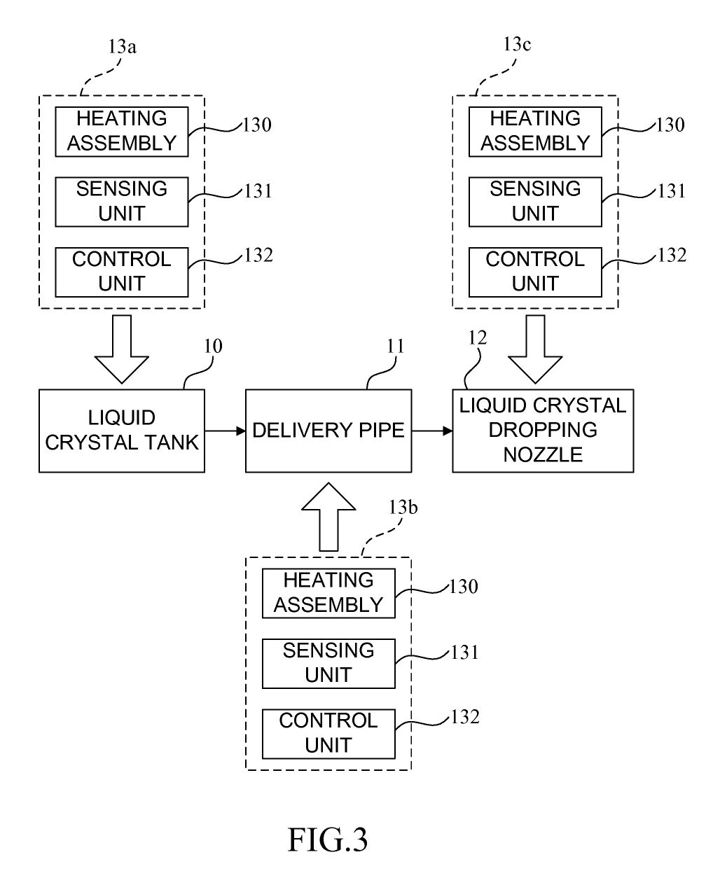

With reference to FIG. 3, FIG. 3 is a block diagram of a second embodiment of the liquid crystal dispensing device having temperature control in accordance with the present invention. The second embodiment of the present invention is similar to the first embodiment of the present invention, so as to use similar terms and numerals, but the difference of the second embodiment is characterized in that: the liquid crystal dispensing device has a first temperature controller 13a, a second temperature controller 13b and a third temperature controller 13c attached to a side of the liquid crystal tank 10, the delivery pipe 11 and the liquid crystal dropping nozzle 12, respectively. Being similar to the temperature controller 13 in the first embodiment, the first temperature controller 13a, each of the second temperature controller 13b and the third temperature controller 13c has a heating component 130, a sensing unit 131 and a control unit 132. The heating component 130 is used to heat the liquid crystal in the liquid crystal tank 10, the delivery pipe 11 or the liquid crystal dropping nozzle 12. The sensing unit is used to sense the temperature of the liquid crystal in the liquid crystal tank 10, the delivery pipe 11 or the liquid crystal dropping nozzle 12 and send back corresponding temperature information. The control unit 132 is used to receive the temperature information and adjust the heating temperature of the corresponding heating component 130 according to the temperature information, so as to stably control the temperature of the liquid crystal.

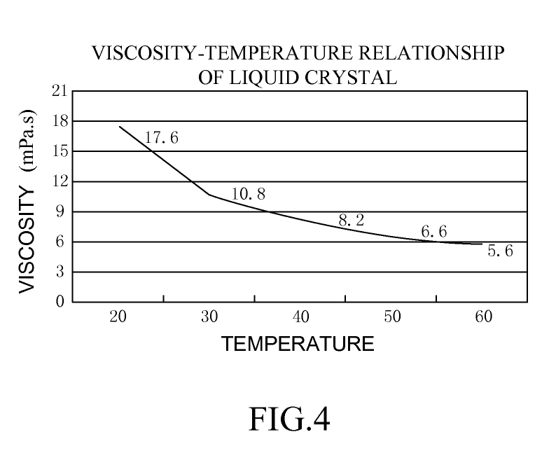

With reference to FIG. 4, FIG. 4 is a characteristic curve chart of viscosity to temperature of liquid crystal. As shown in FIG. 4, the present invention can lower viscosity of the liquid crystal by heating it. When the liquid crystal with lower viscosity is dropped on the alignment film, a spread area of the liquid crystal drop on the alignment film is larger than a spread area of the one with higher viscosity, and a contact angle of the liquid crystal drop to the alignment film is relatively smaller. Therefore, an impact made on the alignment film can be reduced and further reduce occurrence of drop-mura defect. In order to achieve a desired effect, the temperature of the liquid crystal is preferably to be controlled in a range of a room temperature to 50° C., or the viscosity of the liquid crystal before dropping is to be maintained in a range of 7 mPa·s to 15 mPa·s.

With the foregoing description, comparing with the conventional liquid crystal dispensing device that increases the amount of liquid crystal drops and decreases the volume of each liquid crystal drop to overcome drop-mura defect and thereby influences operation accuracy and increases manufacturing time of filling liquid crystal, the present invention mounts at least one temperature controller on a side of the liquid crystal tank, the delivery pipe or the liquid crystal nozzle and lowers the viscosity of the liquid crystal therein by heating, so as to reduce the impact made on the alignment film of a substrate when dropping the liquid crystal, and thereby reduce the occurrence of drop-mura defect. And the present invention does not influence the operation accuracy and increase the manufacturing time for filling liquid crystal.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A liquid crystal dispensing device having temperature control, wherein the liquid crystal dispensing device comprises:
a liquid crystal tank for storing liquid crystal;
a delivery pipe connected to the liquid crystal tank;
a liquid crystal dropping nozzle connected to the delivery pipe; and
a temperature controller selectively mounted on a delivery path constructed by the liquid crystal tank, the delivery pipe and the liquid crystal dropping nozzle and controlling temperature of the liquid crystal in a range of a room temperature to 50° C. to maintain viscosity of the liquid crystal in a range of 7 mPa·s to 15 mPa·s before dropping the liquid crystal.

2. A liquid crystal dispensing device having temperature control, wherein the liquid crystal dispensing device comprises:
a liquid crystal tank for storing liquid crystal;
a delivery pipe connected to the liquid crystal tank;
a liquid crystal dropping nozzle connected to the delivery pipe; and
at least one temperature controller mounted on a delivery path constructed by the liquid crystal tank, the delivery pipe and the liquid crystal dropping nozzle and controlling temperature of the liquid crystal to maintain viscosity of the liquid crystal in a range of 7 mPa·s to 15 mPa·s before dropping the liquid crystal.

3. The liquid crystal dispensing device having temperature control as claimed in claim 2, wherein the liquid crystal dispensing device has a temperature controller that is selectively attached to a side of the liquid crystal tank, the delivery pipe or the liquid crystal dropping nozzle.

4. The liquid crystal dispensing device having temperature control as claimed in claim 2, wherein the liquid crystal dispensing device has a first, a second temperature controller and a third temperature controller attached to a side of the liquid crystal tank, the delivery pipe and the liquid crystal dropping nozzle, respectively.

5. The liquid crystal dispensing device having temperature control as claimed in claim 3, wherein the temperature controller has a heating component used to heat the liquid crystal in the liquid crystal tank, the delivery pipe or the liquid crystal dropping nozzle.

6. The liquid crystal dispensing device having temperature control as claimed in claim 5, wherein the temperature controller further has a sensing unit and a control unit, wherein the sensing unit is used to sense the temperature of the liquid crystal in the liquid crystal tank, the delivery pipe or the liquid crystal dropping nozzle and send corresponding temperature information to the control unit; the control unit is used to adjust the heating temperature of the heating component according to the temperature information.

7. The liquid crystal dispensing device having temperature control as claimed in claim 4, wherein the first, the second and the third temperature controllers respectively have a heating component used to heat the liquid crystal in the liquid crystal tank, the delivery pipe or the liquid crystal dropping nozzle.

8. The liquid crystal dispensing device having temperature control as claimed in claim 7, wherein each of the first, the second and the third temperature controllers further has a sensing unit and a control unit, wherein the sensing unit is used to sense the temperature of the liquid crystal in the liquid crystal tank, the delivery pipe or the liquid crystal dropping nozzle and send corresponding temperature information to the control unit; the control unit is used to adjust the heating temperature of the heating component according to the temperature information.
